(19) United States
(12) Patent Application Publication
(10) Pub. No.: US 2006/0276182 A1
(43) Pub. Date: Dec. 7, 2006

(54) Method of handling call requests in a communication network

(76) Inventor: Zhao Hui Feng, Qing Dao City (CN)

Correspondence Address: HARNESS, DICKEY & PIERCE, P.L.C., P.O. BOX 8910, RESTON, VA, 20195, US

(21) Appl. No.: 11/145,995

(22) Filed: Jun. 7, 2005

(51) Int. Cl. H04Q 7/38

(52) U.S. Cl. 455/414.1

(57) ABSTRACT

In an embodiment of the present invention, a call request is received from a calling party. A ring tone is selectively provided to the calling party based on at least one of a calling party identifier and a time parameter. In another embodiment of the present invention, a call request is received from a calling party. A message including a video element is selectively provided based on at least one of a calling party identifier and a time parameter.

### BACKGROUND OF THE INVENTION

1. Field of the Invention

The present invention relates generally to a method of handling call requests in a communication network, and more particularly to a method of responding to a call request in a communication network.

2. Description of the Related Art

A cellular communications network typically includes a variety of communication nodes coupled by wireless or wired connections and accessed through different types of communications channels. Each of the communication nodes includes a protocol stack that processes the data transmitted and received over the communications channels. Depending on the type of communications system, the operation and configuration of the various communication nodes can differ and are often referred to by different names. Such communications systems include, for example, a Code Division Multiple Access 2000 (CDMA2000) system and Universal Mobile Telecommunications System (UMTS).

UMTS is a wireless telephony standard which describes a set of protocol standards. UMTS sets forth the protocol standards for the transmission of voice and data between a base station (BS) or Node B and a mobile or UE. UMTS systems typically include multiple RNCs. The RNC in UMTS networks provides functions equivalent to the Base Station Controller (BSC) functions in GSM/GPRS networks. However, RNCs may have further capabilities including, for example, autonomously managing handovers without involving mobile switching centers (MSCs) and Serving General Packet Radio Service (GPRS) Support Nodes (SGSNs). The Node B is responsible for air interface processing and some Radio Resource Management functions. The Node B in UMTS networks provides functions equivalent to the Base Transceiver Station (BTS) in GSM/GPRS networks. Node Bs are typically physically co-located with existing GSM base transceiver station (BTS) to reduce the cost of UMTS implementation and minimize planning consent restrictions.

Interfaces typically employed in UMTS systems will now be described. The “Iu” refers to an interface between an RNC and either a MSC or a SGSN. The Iu may be either a circuit-switched (e.g., Iu-CS) or packet-switched (e.g., Iu-PS) connection for carrying voice traffic and signaling (e.g., for Iu-CS) or data traffic and signaling (e.g., for Iu-PS). A typical signaling protocol used by the Iu is Radio Access Network Application Protocol (RANAP).

The “Iur” refers to an interface between RNCs. The primary purpose of the Iur is to support inter-MSC mobility. When a UE moves between areas served by different RNCs, the mobile subscriber's data is transferred to the new RNC via the Iur. The original RNC is known as the Serving RNC and the new RNC is known as the Drift RNC. The main signaling protocol used is Radio Network Sublayer Application Part (RNSAP).

The “Iub” refers to an interface between a plurality of Node B's or BSs and an RNC. The Iub may be used by an RNC to control multiple Node B's. The main signaling protocol used is Node B Application Part (NBAP).

The “Uu” refers to an air interface between the UE and a Node B (or in the case of handoff, more than one Node B).

FIG. 1 illustrates a conventional communication system 100 operating in accordance with UMTS protocols. Referring to FIG. 1, the communication system 100 may include a number of Node Bs such as Node Bs 120, 122 and 124, each serving the communication needs of UEs such as UEs 105 and 110 in their respective coverage area. The Node Bs are connected to an RNC such as RNCs 130 and 132, and the RNCs are connected to a MSC/SGSN 140. The RNC handles certain call and data handling functions, such as, as discussed above, autonomously managing handovers without involving MSCs and SGSNs. The MSC/SGSN 140 handles routing calls and/or data to other elements (e.g., RNCs 130/132 and Node Bs 120/122/124) in the network or to an external network. Further illustrated in FIG. 1 are the conventional interfaces Uu, Iub, Iur and Iub (discussed above).

FIG. 2 illustrates a call origination between UE 105 and UE 110 in the communication system 100 of FIG. 1. Referring to FIG. 2, a user of the UE 105 begins the call by entering digits of a phone number for designating the UE 110 as a communication partner. After the user enters the phone number, the UE 105 transmits the phone number over the air interface Uu to the Node B 120. The Node B 120 transfers an initial address message (IAM) over the Iub to the RNC which then transfers the IAM over the Iu to the MSC/SGSN 140. The MSC/SGSN 140 routes the IAM to the RNC 132 serving the UE 110 via the Iu. The RNC 132 routes the IAM to the Node B 124 via the Iub, and the Node B 124 sends the IAM to the UE 110 via the air interface Uu.

The UE 110 sends an address complete message (ACM) to the UE 105 via the MSC/SGSN 140 in response to the received IAM. The MSC/SGSN 140 responds to the ACM by establishing an audio connection between the UE 105 and the UE 110. At this point, the UE 105 typically hears an initial audio response or ring tone (e.g., ringing, a busy signal, an answering machine, etc.). The UE 110 begins voice communication with the UE 105 by going “off-hook”; namely, sending an answer message (ANM) to the UE 105 through the communication network 100. The ring tone (e.g., ringing, a busy signal, an answering machine, etc.) is replaced by the voice communication after the UE 110 sends the ANM to the UE 105.

### SUMMARY OF THE INVENTION

An example embodiment of the present invention is directed to a method of selectively providing a ring tone, including receiving a call request from a calling party and selectively providing a ring tone to the calling party based on at least one of a calling party identifier and a time parameter.

Another example embodiment of the present invention is directed to a method of selectively providing a message including a video element, including receiving a call request from a calling party and selectively providing a message including a video element based on at least one of a calling party identifier and a time parameter.

### BRIEF DESCRIPTION OF THE DRAWINGS

The present invention will become more fully understood from the detailed description given herein below and the accompanying drawings which are given by way of illustration only, wherein like reference numerals designate corresponding parts in the various drawings, and wherein:

FIG. 1 illustrates a conventional communication system operating in accordance with Universal Mobile Telecommunications System (UMTS) protocols.

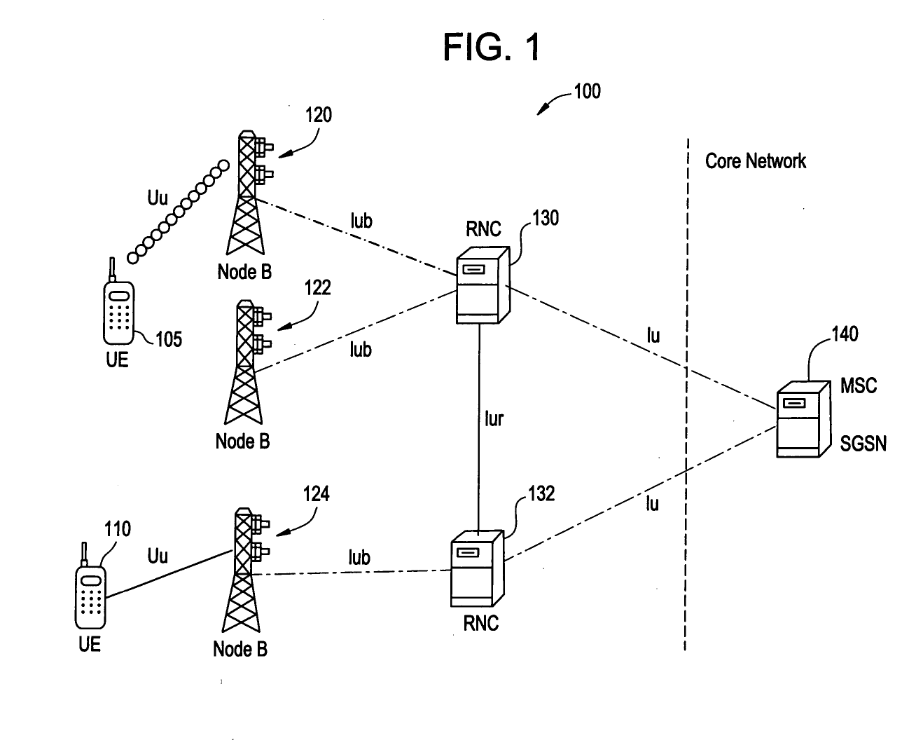

FIG. 2 illustrates a call initiation between first and second user equipments (UEs) in the communication system of FIG. 1.

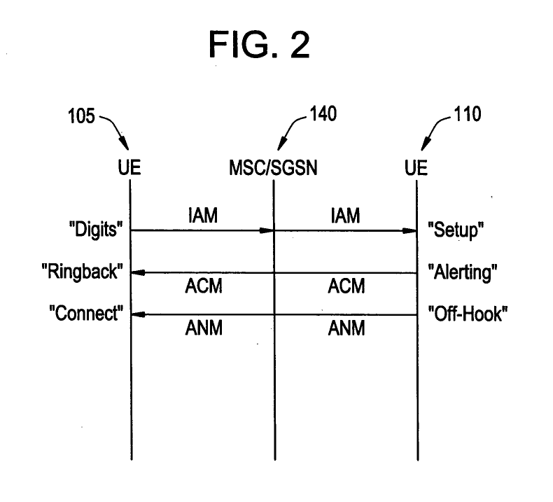

FIG. 3 illustrates a communication system operating in accordance with UMTS protocols.

FIG. 4 illustrates a communication flow diagram for responding to a call request according to an example embodiment of the present invention.

FIG. 5 illustrates a communication flow diagram for responding to a call request according to another example embodiment of the present invention.

FIG. 6 illustrates a communication flow diagram for establishing a voice connection after a special ring tone is sent in accordance with the communication flow diagram of FIG. 5.

FIG. 7 illustrates a communication flow diagram for establishing a voice connection after the special ring tone is sent in accordance with the communication flow diagram of FIG. 4.

FIG. 8 illustrates a communication flow diagram of a call termination according to another example embodiment of the present invention.

### DETAILED DESCRIPTION OF THE INVENTION

In order to better understand the present invention, an example of a communication system according to an example embodiment of the present invention will be described. This will be followed by a description of example methodologies of the present invention implemented at the communication system.

### Communication System

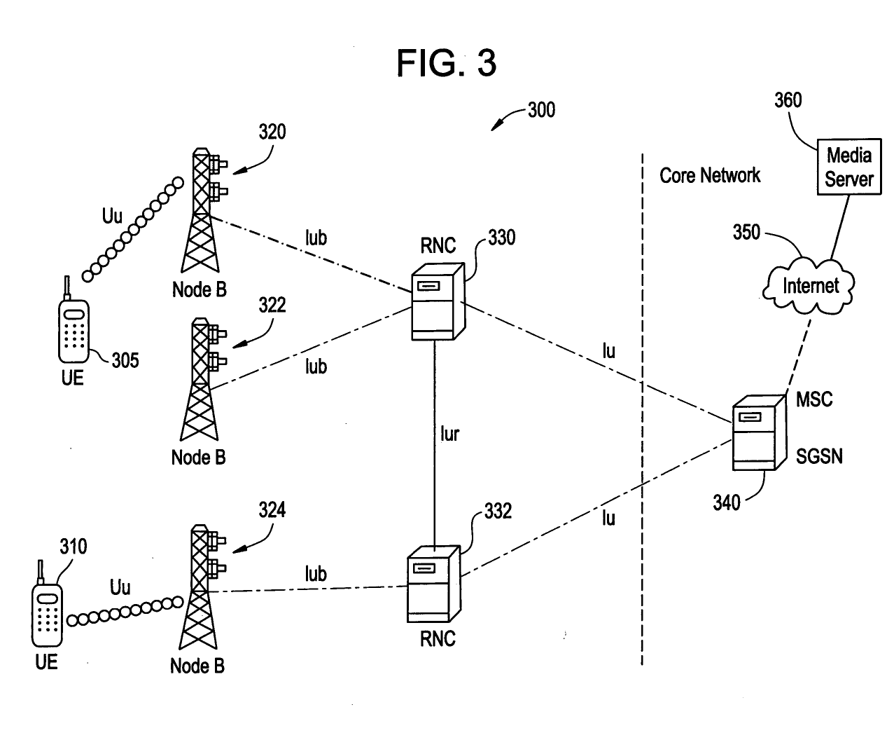

FIG. 3 illustrates a communication system 300 operating in accordance with Universal Mobile Telecommunications System (UMTS) protocols.

Referring to FIG. 3, the communication system 300 may include a number of Node Bs such as Node Bs 320, 322 and 324, each serving the communication needs of User Equipments (UEs) such as UEs 305 and 310 in their respective coverage area. The Node Bs are connected to a radio network controller (RNC) such as RNCs 130 and 132, and the RNCs are connected to a mobile switching center (MSC)/Serving General Packet Radio Service (GPRS) Support Nodes (SGSN) 340. The RNC handles certain call and data handling functions, such as autonomously managing handovers without involving MSCs and SGSNs. The MSC/SGSN 340 handles routing calls and/or data to other elements (e.g., RNCs 330/332 and Node Bs 320/322/324) in the network or to an external network. Further illustrated in FIG. 3 are conventional interfaces Uu, Iub, Iur and Iub.

The communication system 300 further includes an interface between the MSC/SGSN 340 and an internet connection 350. A media server 360 is accessible to the MSC/SGSN 340 through the internet connection 350.

### First Example of Responding to a Call Request

A first example of responding to a call request initiated by the UE 305 in the communication system 300 will now be described.

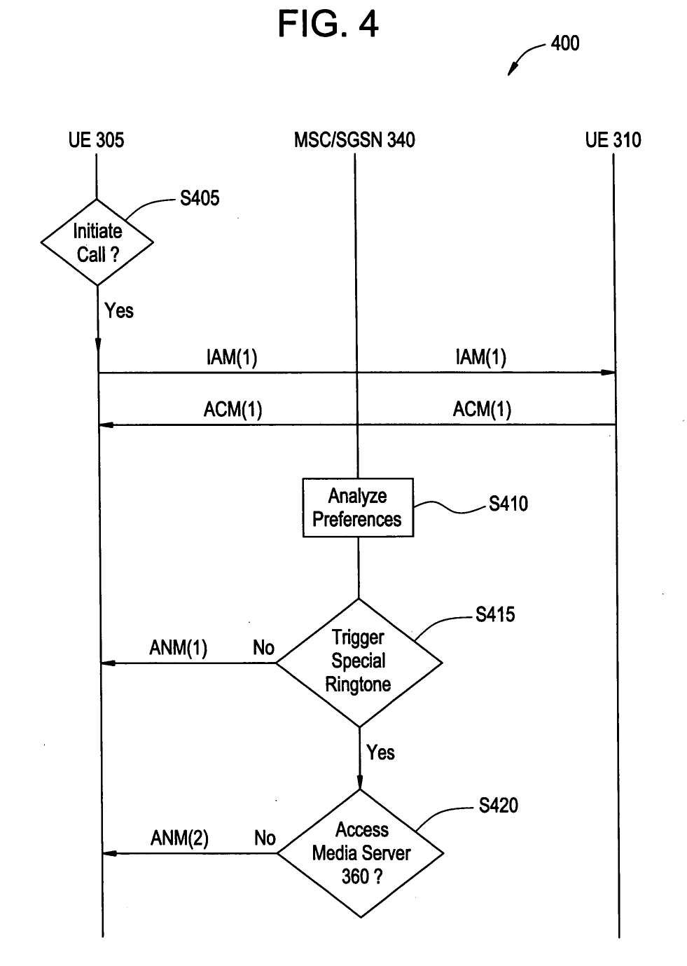

FIG. 4 illustrates a communication flow diagram 400 for responding to a call request according to an example embodiment of the present invention. In step S405, a user operating the UE 305 determines whether to make a phone call. If the user opts to initiate a call, the user enters a phone number for designating the called party into the UE 305. The UE 305 transmits an initial address message (IAM) IAM(1) over the air interface Uu to the Node B 320. The Node B 320 transfers the IAM(1) over the Iub to the RNC 330 which then transfers the IAM(1) over the Iu to the MSC/SGSN 340. The MSC/SGSN 340 routes the IAM(1) to the RNC 332 serving the UE 310 via the Iu. The RNC 332 routes the IAM(1) to the Node B 324 via the Iub, and the Node B 324 sends the IAM(1) to the UE 310 via the air interface Uu. The UE 310 sends an address complete message (ACM) ACM(1) to the UE 305 in response to the received IAM(1).

After the ACM(1) is sent to the UE 305 from the UE 310, the MSC/SGSN 340 analyzes special ring tone preferences for the UE 310 stored at the MSC/SGSN 340 in step S410. The special ring tone preferences may include a list of phone numbers, times and/or other information. The special ring tone preferences may further include links to special ring tones, which may be triggered based on the analysis of the special ring tone preferences for the UE 310. The special ring tone preferences and the associated special ring tones will be described later in further detail.

After the special ring tone preferences for the UE 310 are analyzed in step S410, the MSC/SGSN 340 determines whether to trigger a special ring tone in step S415. For example, if the MSC/SGSN 340 determines that the special ring tone is not triggered, the MSC/SGSN 340 may send an answer message (ANM) ANM(1) to the UE 305. In this example, a default initial audio response or ring tone (e.g., ringing, a busy signal, an answering machine, etc.) is received by the UE 305 until the UE 310 chooses to establish a voice connection by going “off-hook”.

Alternatively, in another example, if the MSC/SGSN 340 determines the special ring tone is triggered in step S415, the process advances to step S420. In step S420, the MSC/SGSN 340 determines whether access to the media server 360 is required to obtain the special ring tone. In the example embodiment of FIG. 4, the MSC/SGSN 340 determines that access to the media server 360 is not required because the special ring tone is stored locally in the MSC/SGSN 340. The MSC/SGSN 340 routes the special ring tone ANM(2) to the UE 305. The UE 305 receives the special ring tone ANM(2) as designated by the UE 310.

### Second Example of Responding to a Call Request

A second example of responding to a call request initiated by the UE 305 in the communication system 300 will now be described.

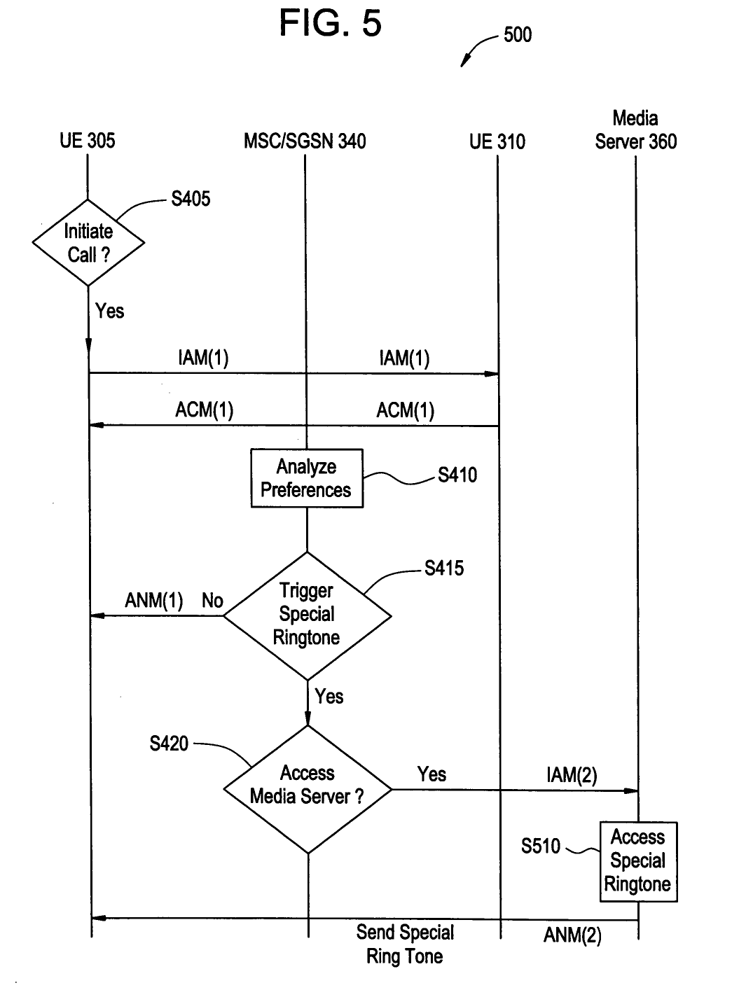

FIG. 5 illustrates a communication flow diagram 500 for responding to a call request according to another example embodiment of the present invention. The communication flow diagram 500 of FIG. 5 is identical to the communication flow diagram 400 of FIG. 4 until the step S420. In the example embodiment of FIG. 5, at step S420, the MSC/SGSN 340 determines that access to the media server 360 is required to acquire the special ring tone. The MSC/SGSN 340 sends a second initial address message IAM(2) through the internet 350 to the media server 360 to request the special ring tone.

The media server 360 receives the IAM(2) and accesses the requested special ring tone in step S510. The media server 360 sends the special ring tone ANM(2) to the MSC/SGSN 340 which forwards the special ring tone ANM(2) to the UE 305. The UE 305 receives the special ring tone ANM(2) as designated by the UE 310.

### Examples of Establishing a Voice Connection after Special Ring Tone

Examples of establish a voice connection after sending a special ring tone will now be described.

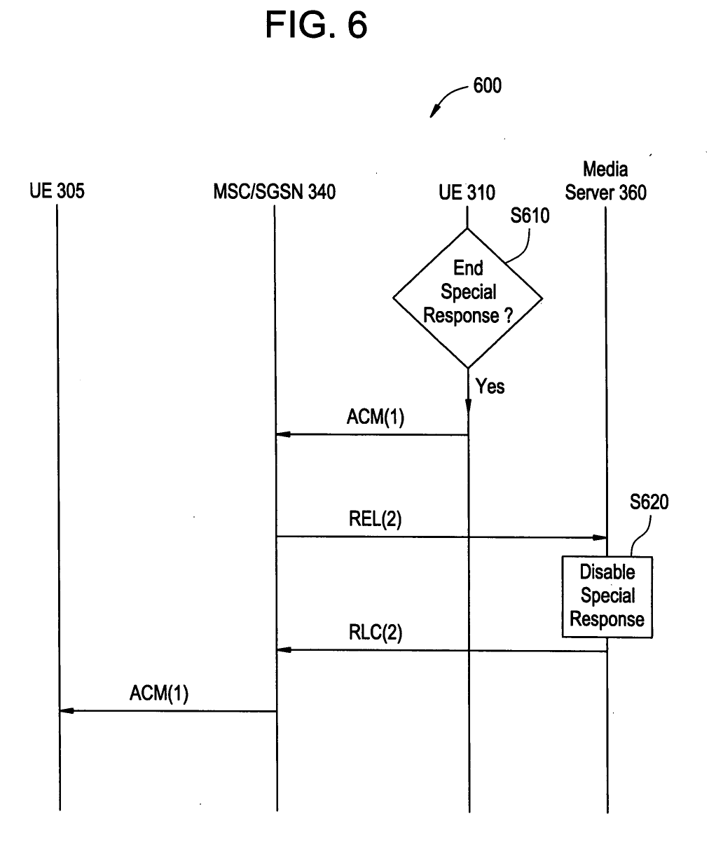

FIG. 6 illustrates a communication flow diagram 600 for establishing a voice connection after the special ring tone is sent in accordance with the communication flow diagram 500 of FIG. 5.

In step S610, a subscriber using the UE 310 determines to end the special ring tone and establish a voice connection with the UE 305. The UE 310 sends an answer message ANM(1) to the MSC/SGSN 340 to trigger the voice connection with the UE 305. The MSC/SGSN 340 sends a release message REL(2) through the internet 350 to the media server 360 to disable the special ring tone ANM(2). The media server 360 disables the special ring tone ANM(2) in step S620 in response to the release message REL(2). The media server 360 sends a release complete message RLC(2) to acknowledge the receipt of the release message RLC(2) and the disabling of the special ring tone ANM(2). The MSC/SGSN 340 sends the answer message ANM(1) to the UE 305 to establish the voice connection.

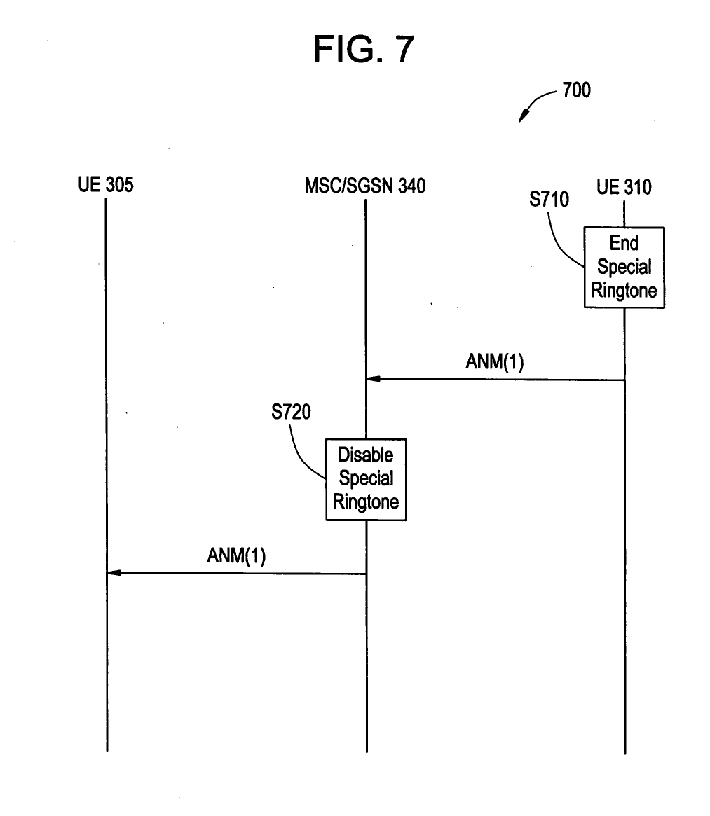

FIG. 7 illustrates a communication flow diagram 700 for establishing a voice connection after the special ring tone is sent in accordance with the communication flow diagram 400 of FIG. 4.

In step S710, a user of the UE 310 determines to end the special ring tone and establish a voice connection with the UE 305. The UE 310 sends an answer message ANM(1) to the MSC/SGSN 340 to indicate that UE 310 wishes to establish the voice connection with the UE 305. The MSC/SGSN 340 disables the special ring tone ANM(2) in step S720 and sends the answer message ANM(1) to the UE 305 to establish the voice connection between the UE 305 and the UE 310.

### Example of Call Termination

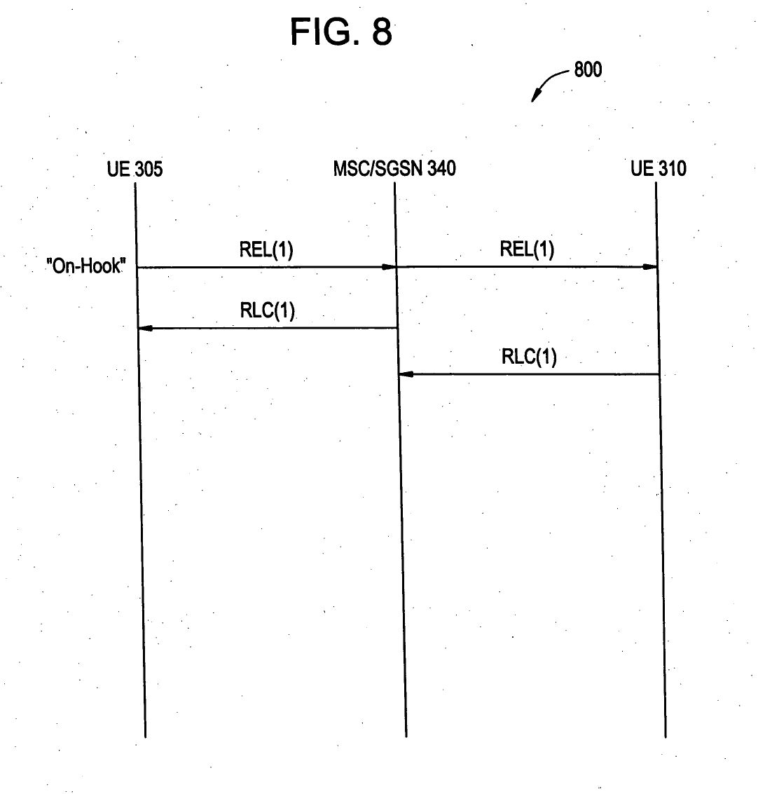

FIG. 8 illustrates a communication flow diagram 800 of a call termination according to another example embodiment of the present invention. For example, the call termination illustrated by the communication flow diagram 800 may terminate a voice connection after a voice connection is established as illustrated in either of the communication flow diagram 600 of FIG. 6 or the communication flow diagram 700 of FIG. 7.

In step S810, the UE 305 determines to terminate a voice connection with the UE 310. The UE 305 goes “On-Hook” and sends a release message REL(1) to the MSC/SGSN 340 which is then forwarded to the UE 310. The MSC/SGSN 340 responds to the release message REL(1) by sending a release complete message RLC(1) to the UE 305. The UE 310 responds to the release message RLC(1) by sending the release complete message RLC(1) to the MSC/SGSN 340. After the release message REL(1) has been received by all parties involved in the voice connection between the UE 305 and the UE 310, no further communication occurs between the UE 305 and the UE 310 until a request is made for a new call between the UE 305 and the UE 310.

### Special Ring Tone Preferences

Examples of special ring tone preferences used to determine whether to trigger a special ring tone in step S410 of FIGS. 4/5 will now be given.

A subscriber using the UE 310 may be given the option of creating or modifying a profile including preferences with regard to special ring tones for responding to call requests. The profile may establish special ring tone criteria which may trigger a designated special ring tone. For example, the special ring tone criteria may include a calling party identifier. In another example, the subscriber may enter a list of calling party identifiers (e.g., phone numbers) for which a given special ring tone is triggered. All calling parties that are not identified in the list do not trigger the special ring tones.

Alternatively, in another example, the subscriber may enter a list of calling party identifiers for which no special ring tone is triggered. In this example, all calling parties that are not in the list trigger a given special ring tone.

In another example, the special ring tone criteria may include a time parameter. For example, the subscriber may enter a time or range(s) of times for when a given special ring tone is triggered. All calling parties calling the subscriber within the designated ranges of times receive the given special ring tone.

Alternatively, in another example, the subscriber may enter a time or range(s) of times for when a given special ring tone is not triggered. All calling parties (e.g., irrespective of their calling party identifier) which call the subscriber within the designated ranges of times do not receive the special ring tone. For example, even if the calling party matches a calling party identifier designated in the special ring tone criteria for triggering the special ring tone, the call request may also be required to satisfy the time parameter for a special ring tone to be triggered. It is further understood that the time parameter may be associated with particular calling parties or with all calling parties. Namely, both a calling party identifier and a calling time range may be combined to filter calls for which a special ring tone is to be or not to be triggered.

### Examples Methods of Selecting Ring Tone Preferences

Examples methods of selecting special ring tone preferences will now be given. In a first example, a subscriber of the UE 310 uses a computer to access a website of a service provider. The website includes at least one webpage devoted to special ring tone preference selections. The subscriber logs onto their account via the webpage to access her or her personal profile and personal special ring tone preferences.

The subscriber may use a series of menu options (e.g., drop down menus) provided by the webpage to select from a list of audio files, video files and/or combination files (e.g., including both audio and video elements). The subscriber may also use a series of menu options to select from a list of phone numbers and/or timing information to correlate between the selected audio/video files.

Alternatively, the subscriber may use the UE 310 or other communication device to call the service provider. A manual or automated operator may respond to the subscriber via the communication device. The subscriber may relate desired special ring tone preference selections by either speaking them or entering them into the communication device (e.g., through a numeric keypad). In an example, if the subscriber calls the service provider on the UE 310, the subscriber may not be required to enter identifying information (e.g., because the subscriber may be automatically associated with his or her account information via the UE 310).

It will be readily understood by one of ordinary skill in the art that various alterative methods may be employed for establishing a given subscriber's special ring tone preferences.

### Special Ring Tone Examples

Examples of special ring tones will now be given. In a first example, the special ring tone may be stored at the MSC/SGSN 340. In this example, the special ring tone may be any response typically associated with phone calls (e.g., a ring, a dial tone, a busy signal, an answering machine message, etc.).

In a second example, the special ring tone may be stored at the media server 360 accessible to the MSC/SGSN 340 via the internet 350. In this example, the special ring tone may be any type of audio file, video file or combination thereof. For example, the subscriber may store a song as the special ring tone at the media server 360. In another example, the subscriber may store a video and/or image as the special ring tone at the media server 360. In yet another example, the subscriber may store a combination of an audio file and a video file (e.g., a music video) at the media server 360 as the special ring tone.

Each given special ring tone stored at the media server 360 or the MSC/SGSN 340 may correlate to one or more of a calling party identifier, a time parameter, a combination of a calling party identifier and a time parameter, etc., within the special ring tone preferences (e.g., designated by a user of the UE 310) stored at the MSC/SGSN 340.

### Applications

Examples of specific applications of the above-described example embodiments will now be given with reference to the above-described figures.

In a first example, the subscriber is an employee who wishes to avoid his or her boss on the weekends. In this example, the subscriber enters special ring tone criteria including a calling party identifier and a time parameter. The calling party identifier is the boss's phone number and the time parameter is a range of times beginning Saturday morning and ending Sunday night. To satisfy the special ring tone criteria in this example, both the calling party identifier and the associated time parameter must be satisfied. The special ring tone selected by the subscriber in this example may be a busy signal, which may be stored locally at the MSC/SGSN 340. Calls received by the subscriber (UE 310) from the subscriber's boss (UE 305) satisfying the special ring tone criteria may proceed as illustrated in the communication flow diagram 400 of FIG. 4 (e.g., because the media server 360 need not be accessed to acquire the special ring tone). Thus, when calling the subscriber on a weekend, the subscriber's boss hears a busy signal instead of, for example, a ringing, which may avoid a suspicion that the subscriber is ignoring the boss's call.

In a second example, the subscriber wishes to play a “Happy Birthday” song to his or her friends for calls received on their respective birthdays. In this example, the subscriber enters special ring tone criteria including a calling party parameter and a time parameter. The calling party parameter is a calling party identifier for each calling party for which the subscriber wishes to play the “Happy Birthday” song on his or her birthday. The time parameter is the birthday associated with each of the respective calling parties. To satisfy the special ring tone criteria in this example, both the calling party parameter and the associated time parameter must be satisfied. The special ring tone selected by the subscriber in this example is a “Happy Birthday” song stored at the media server 360. As such, calls received by the subscriber (UE 310) from the subscriber's friends (UE 305) satisfying the special ring tone criteria may proceed as illustrated in the communication flow diagram 500 of FIG. 5 (e.g., because the media server 360 must be accessed to acquire the special ring tone). After a given time period where the special ring tone is played for the calling party (UE 305), the subscriber (UE 310) may end the special ring tone and commence voice communication with the calling party (UE 305) in accordance with communication flow diagram 600 of FIG. 6.

The example embodiments of the present invention being thus described, it will be obvious that the same may be varied in many ways. For example, while the special ring tone is above-described as being a type of audio response, it is understood that in other example embodiments the special ring tone may include an image and/or video playback or a combination of an audio playback and an image or video playback. Further, while the above-described example embodiments have been given with respect to a communication system operating in accordance with UMTS protocols, it is understood that other example embodiments of the present invention may be applied in wired communication systems (e.g., land-line communication systems) and/or other types of wireless communication systems (e.g., GSM, CDMA2000 etc.). It is further understood that the example embodiments of the present invention may be employed irrespective of an operation status of the UE 305. For example, the operating status may include whether or not the called party (UE 310) is currently engaged in a call and whether or not the called party is currently capable of receiving calls (e.g., whether the UE 310 is “powered on” or not).

Such variations are not to be regarded as a departure from the spirit and scope of the exemplary embodiments of the invention, and all such modifications as would be obvious to one skilled in the art are intended to be included within the scope of the invention.

We claim:

1. A method of selectively providing a ring tone, comprising:
receiving a call request from a calling party; and
selectively providing a ring tone to the calling party based on at least one of a calling party identifier and a time parameter.

2. The method of claim 1, wherein the selectively providing step provides the ring tone irrespective of an operating status of the called party.

3. The method of claim 2, wherein the operating status includes one of whether or not the called party is currently engaged in a call and whether or not the called party is currently capable of receiving calls.

4. The method of claim 1, wherein the calling party identifier and the time parameter are designated by a called party.

5. The method of claim 1, wherein the selectively providing step further comprises:
comparing the call request with the at least one of the calling party identifier and the time parameter.

6. The method of claim 1, wherein the selectively providing step provides the ring tone when the calling party is first associated with the calling party identifier.

7. The method of claim 6, wherein the selectively providing step compares the calling party with the calling party identifier and provides the ring tone if the comparison determines a match.

8. The method of claim 7, wherein the calling party identifier is an entry in a list including a plurality of calling party identifiers and the selectively providing step compares the calling party with each of the plurality of calling party identifiers to determine whether a match exists.

9. The method of claim 6, wherein the selectively providing step provides the ring tone when the call request is second associated with the time parameter.

10. The method of claim 9, wherein the time parameter includes a time range and the selectively providing step compares the time range with a given time of the call request and selectively provides the ring tone based on the comparison.

11. The method of claim 10, wherein the time range is one of a plurality of time ranges included in the time parameter and the selectively providing step compares the given time of the call request with the plurality of time ranges to determine whether the call request is made within one of the plurality of time ranges.

12. The method of claim 10, wherein the time parameter is an entry in a list including a plurality of time parameters.

13. The method of claim 1, wherein the ring tone is selectively provided when the call request is associated with the time parameter.

14. The method of claim 13, wherein the time parameter includes a time range and the selectively providing step compares the time range with a given time of the call request and selectively provides the ring tone based on the comparison.

15. The method of claim 14, wherein the time range is one of a plurality of time ranges included in the time parameter and the selectively providing step compares the given time of the call request with the plurality of time ranges to determine whether the call request is made within one of the plurality of time ranges.

16. The method of claim 14, wherein the time parameter is an entry in a list including a plurality of time parameters.

17. The method of claim 5, wherein the selectively providing step provides the ring tone when the calling party matches the calling party identifier and a given time of the call request is within a range specified by the time parameter.

18. The method of claim 17, wherein the time parameter and the calling party identifier are included in a list with a plurality of entries, each of the plurality of entries associated with a given ring tone.

19. The method of claim 1, wherein the ring tone is one of a busy signal, a ringing and a song.

20. A method of selectively providing a message including a video element, comprising:
receiving a call request from a calling party; and
selectively providing a message including a video element based on at least one of a calling party identifier and a time parameter.
